(19) United States
(12) Patent Application Publication
(10) Pub. No.: US 2005/0149389 A1
(43) Pub. Date: Jul. 7, 2005

(54) Selling ad space on diapers

(76) Inventor: Thomas Odorzynski, Green Bay, WI (US)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 10/748,715

(22) Filed: Dec. 30, 2003

(51) Int. Cl. G06F 17/60

(52) U.S. Cl. 705/14

(57) ABSTRACT

The present invention relates to a method and system that use diapers as an advertising medium for products other than diapers. The method and system allow diapers manufacturers to generate revenue from other businesses by charging businesses to place ads or promotions on disposable diapers. Each diaper would serve its primary function of containing waste while simultaneously providing advertising space for the sponsors. The present invention relates to (i) a method of advertising that includes selling space on diapers to a sponsor and placing an ad for a product other than diapers onto the diapers; (ii) a system for generating advertising revenue that includes diapers and ads for products other diapers that are placed onto the diapers; and/or (iii) a method of promoting product purchases that includes placing a promotion relating to purchasing the product onto diapers and selling the diapers.

### BACKGROUND

Diapers are an important part of providing quality child care to children. Parents and other child care providers must typically choose between cloth diapers and disposable diapers. The combination of low cost and ease of use have made disposable diapers the primary choice for parents and other child care providers.

Disposable diapers come in every imaginable shape and size, and are typically purchased based on cost, size, absorbency and aesthetic appearance (among other factors). Some disposable diapers include graphics that are designed to amuse children. The graphics depict various characters that may be familiar to children (e.g., Barney, Santa and Cinderella).

One drawback associated with manufacturing diapers that include such well known characters is that licensing fees must typically be paid to the owners of the characters. The licensing fees add unwanted expenses to the cost of producing the diapers. The licensing fees may be significant in view of the enormous number of disposable diapers that are produced every year.

### SUMMARY OF THE INVENTION

The present invention relates to a method and system that use diapers as an advertising medium for products other than diapers. The method and system allow diapers manufacturers to generate revenue from other businesses by charging businesses to place ads or promotions on disposable diapers. Each diaper would serve its primary function of containing waste while simultaneously providing advertising space for the sponsors.

Placing ads on diapers provides an efficient way for sponsors to reach consumers outside normal advertising channels. Ads on disposable diapers may be an effective advertising technique because of the enormous volume of diapers that are purchased by consumers. In addition, the unique means of delivering the ad may be a particularly effective marketing technique because the diapers act as a mini-billboard for advertisements.

In some forms, the present invention relates to a method of advertising. The method includes selling space on diapers to a sponsor and placing an ad for a product other than diapers onto the diapers.

In another form, the present invention relates to a system for generating advertising revenue. The system includes diapers and ads for products other than diapers that are placed onto the diapers.

In still another form, the present invention relates to a method of promoting product purchases. The method includes placing a promotion relating to purchasing the product onto diapers and selling the diapers to customers.

In yet another form, the present invention relates to a system for promoting product purchases. The system includes diapers and promotions related to purchasing the products. The promotions are placed onto the diapers.

It is to be understood that both the foregoing general description and the following detailed description are exemplary and are intended to provide further explanation of the invention claimed. The accompanying drawings, which are incorporated in and constitute part of this specification, are included to illustrate and provide a further understanding of the invention.

### BRIEF DESCRIPTION OF THE DRAWINGS

The present invention will be more fully understood, and further features will become apparent, when reference is made to the following detailed description and the accompanying drawings. The drawings are merely representative and are not intended to limit the scope of the claims. Like parts depicted in the drawings are referred to by the same reference numerals.

FIG. 1 illustrates an example method of advertising that encompasses the present invention.

FIG. 2 illustrates an example system for generating advertising revenue that encompasses the present invention.

FIG. 3 illustrates an example diaper and ad that may be used in the system shown in FIG. 2.

FIG. 4 illustrates another example diaper and ad that may be used in the system shown in FIG. 2.

FIG. 5 illustrates an example method of promoting product purchases that encompasses the present invention.

FIG. 6 illustrates an example system for promoting product purchases that encompasses the present invention.

FIG. 7 illustrates an example diaper and promotion that may be used in the system shown in FIG. 6.

FIG. 8 illustrates another example diaper and promotion that may be used in the system shown in FIG. 6.

### DETAILED DESCRIPTION

In the following detailed description, reference is made to the accompanying drawings, which show specific embodiments in which the invention may be practiced. These embodiments are described in sufficient detail to enable those skilled in the art to practice the invention. It is to be understood that other embodiments may be utilized and structural changes made, such that the following detailed description is not to be taken in a limiting sense.

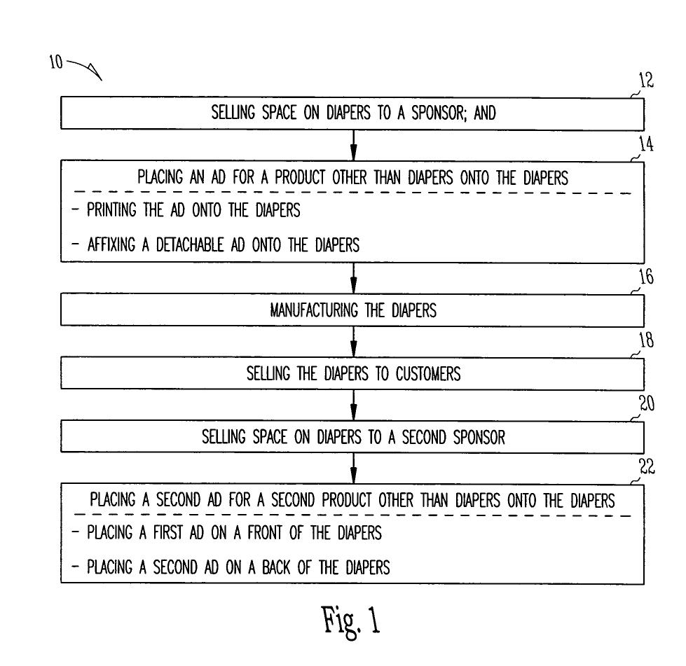

FIG. 1 illustrates a flow diagram of an example method of advertising that embodies the present invention. The method 10 includes 12 selling space on diapers to a sponsor, and 14 placing an ad for a product other than diapers onto the diapers. The method may further include 16 manufacturing the diapers and 18 selling the diapers to customers. As used herein, ad refers to any graphic, or indicia, that are capable of conveying a message to a consumer regarding the product other than diapers.

In some forms of the method, the ad is a first ad, the product is a first product and the sponsor is a first sponsor such that the method may further include 20 selling space on diapers to a second sponsor, and 22 placing an ad for a second product other than diapers onto the diapers. It should be noted that 14 placing the first ad onto the diapers may include placing the first ad on a front (or back) of the diapers, and 22 placing the second ad onto the diapers may include placing the second ad on a back (or front) of the diapers.

In some forms, 14 placing the ad onto the diapers includes printing the ad onto the diapers, and/or affixing a detachable ad onto the diapers. There is no limitation on the number and locations of the ads on the diapers. In addition, some diapers may include one type of ad for a product while other diapers may include a different type of ad for the product.

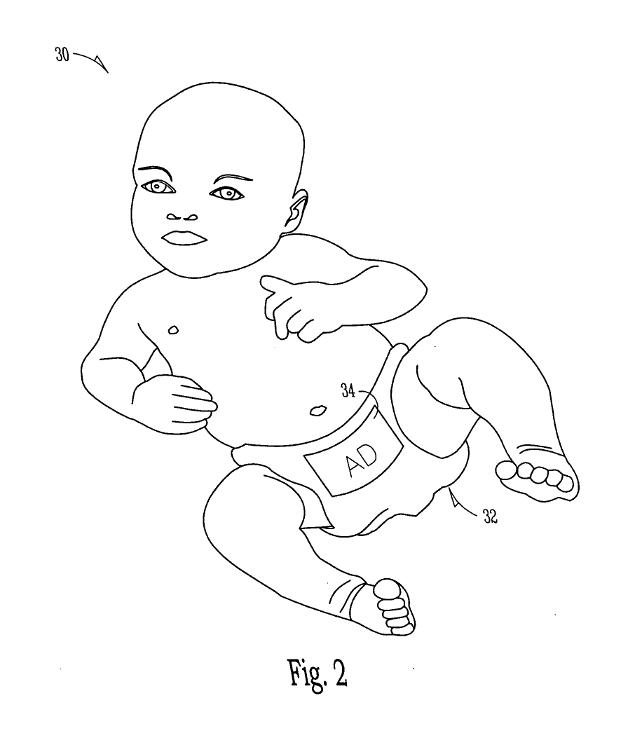

FIG. 2 illustrates an example system 30 for generating advertising revenue. The system 30 includes diapers 32 and ads 34 for products other than diapers that are placed onto the diapers 32.

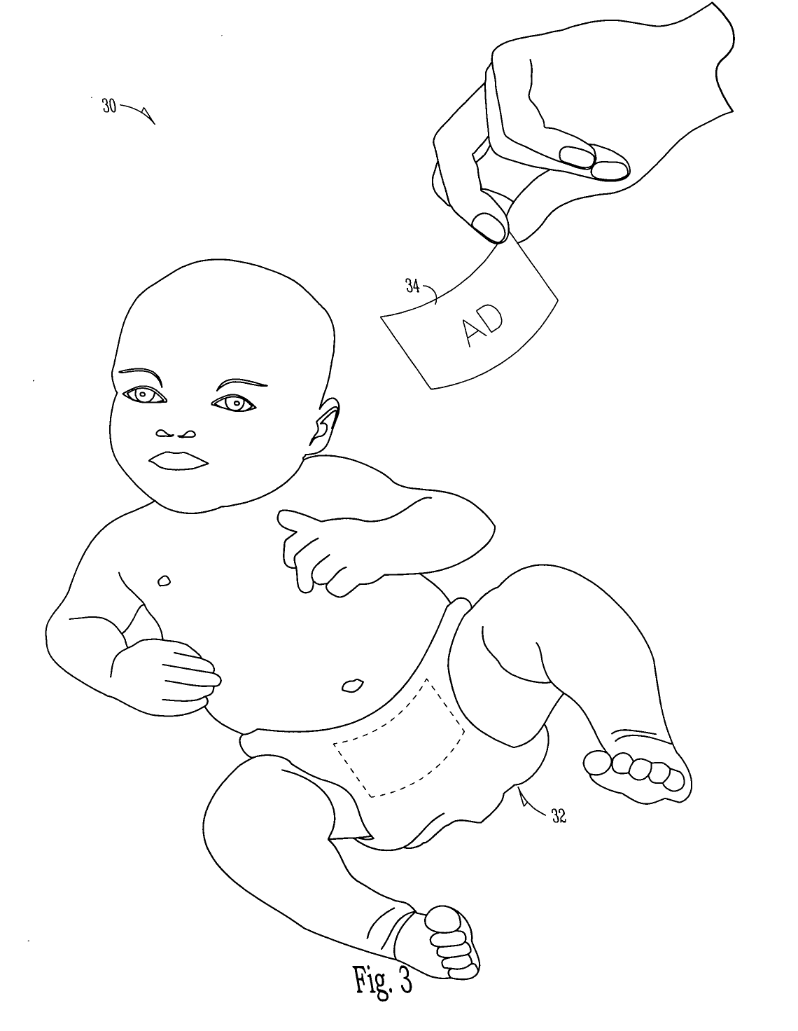

In some forms, the ads 34 may be printed onto the diapers 32. In addition, FIG. 3 shows that the ads 34 may be detachable from the diapers 32.

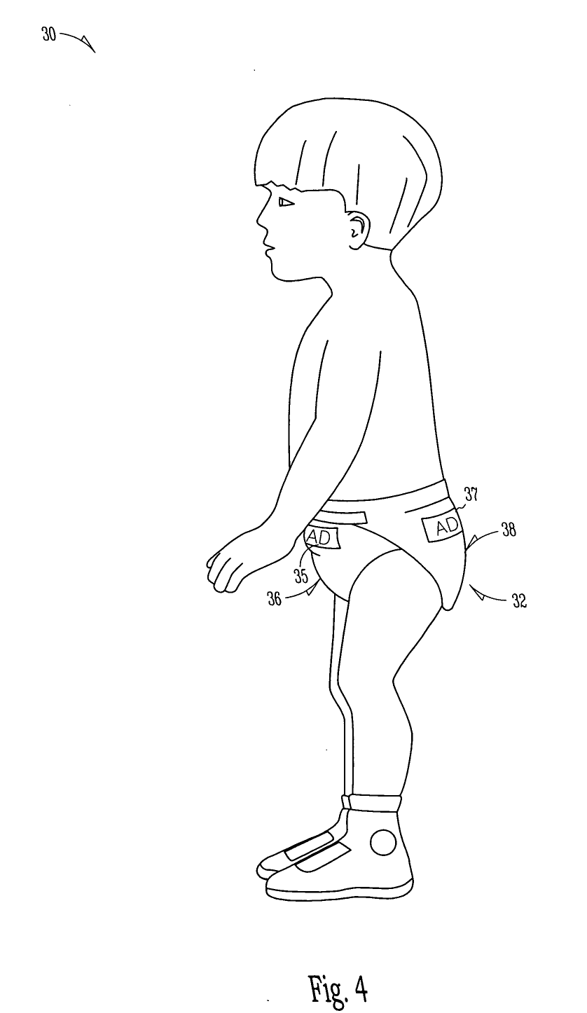

It should be noted that each of the diapers 32 may include one or more ads. As an example, each of the diapers 32 in FIG. 4 includes a first ad 35 on a front 36 of the diapers 32 and a second ad 37 on a back 38 of the diapers 32. Depending on the application where the system 30 is used, the first ad 35 may be for a first product (e.g., hamburgers) other than diapers 32 and the second ad 37 may be for a second product (e.g., toys) other than diapers 32.

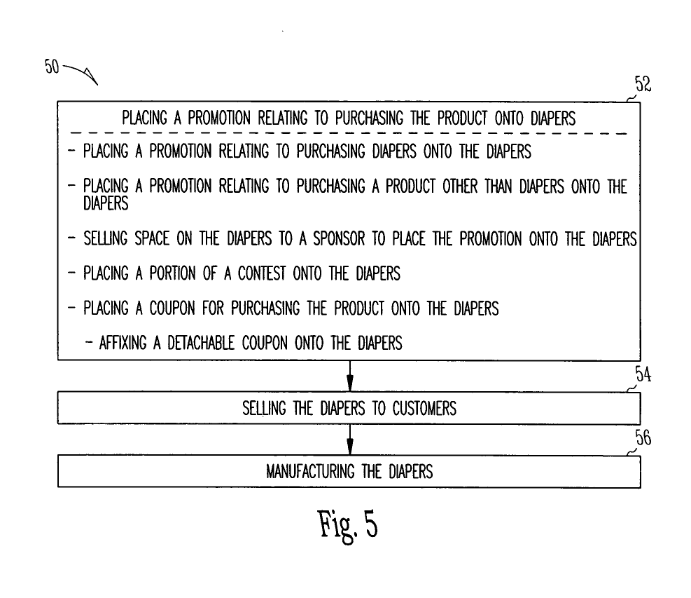

FIG. 5 illustrates an example method 50 of promoting product purchases. The method includes 52 placing a promotion relating to purchasing the product onto diapers, and 54 selling the diapers to customers. As used herein, promotion refers to any graphic, or indicia, that are capable of providing a purchasing benefit to a consumer. It should be noted that a purchasing benefit may include (i) offering a discount on purchasing products; (ii) giving away merchandise to consumers; and/or (iii) awarding a prize to contest winner (among other promotions).

The method may further include 56 manufacturing the diapers. In some forms, 52 placing a promotion onto the diapers may include selling space on the diapers to a sponsor to place the promotion onto the diapers.

Depending on the application where the method 50 is used, 52 placing a promotion onto the diapers may also include (i) placing a promotion relating to purchasing diapers onto the diapers; (ii) placing a promotion relating to purchasing a product other than diapers onto the diapers; and/or (iii) placing a detachable coupon for purchasing the product onto the diapers.

In addition, 52 placing a promotion onto diapers may include placing a portion of a contest onto the diapers. As an example, the promotion on one or more of the diapers may contain information which indicates that the consumer who purchased the diaper has won a prize

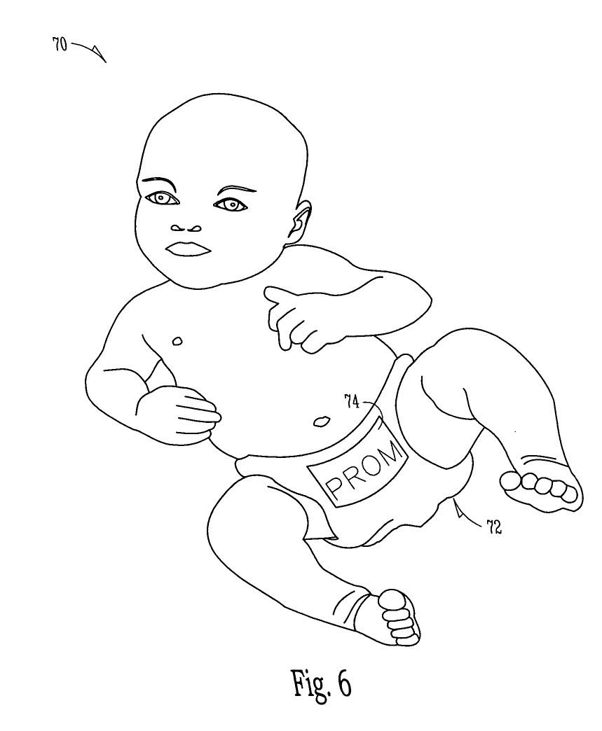

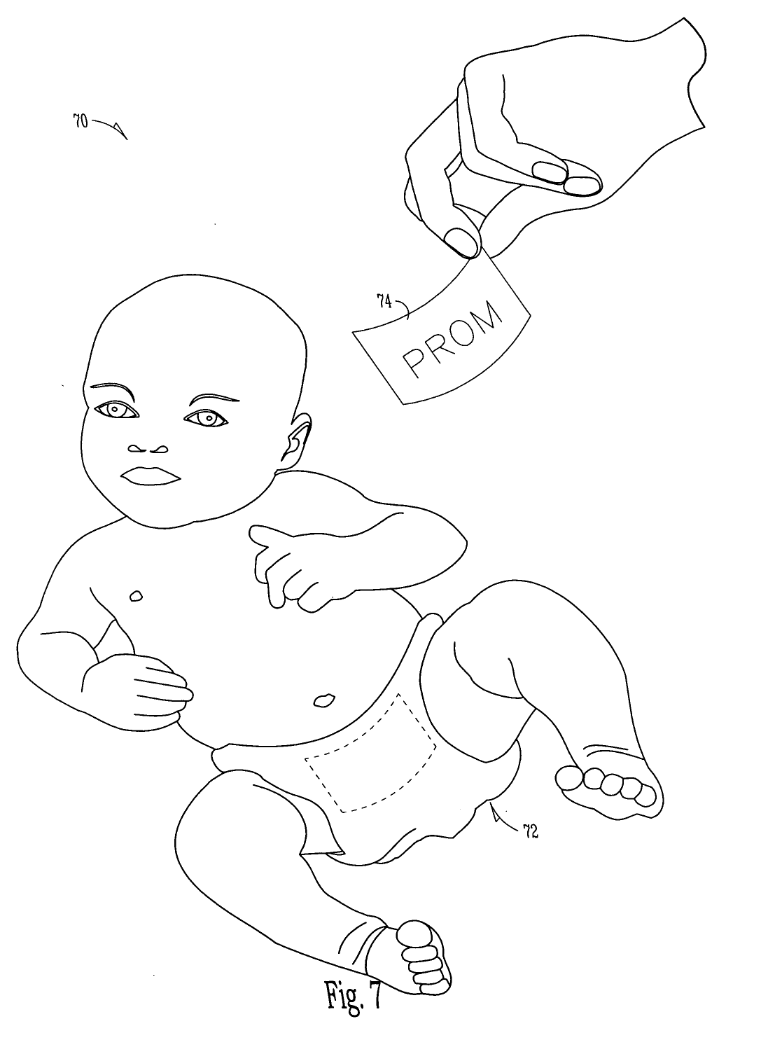

FIG. 6 illustrates an example system 70 for promoting product purchases. The system 70 includes diapers 72 and promotions 74 that are related to purchasing the products. The promotions 74 are placed onto the diapers 72 (e.g., by printing). As shown in FIG. 7, the promotions 74 may be detachable coupons that are related to purchasing the products. The promotions may also be in the form a code, or some other indicator, that the consumer provides to a retailer or manufacturer to obtain a purchasing benefit or prize.

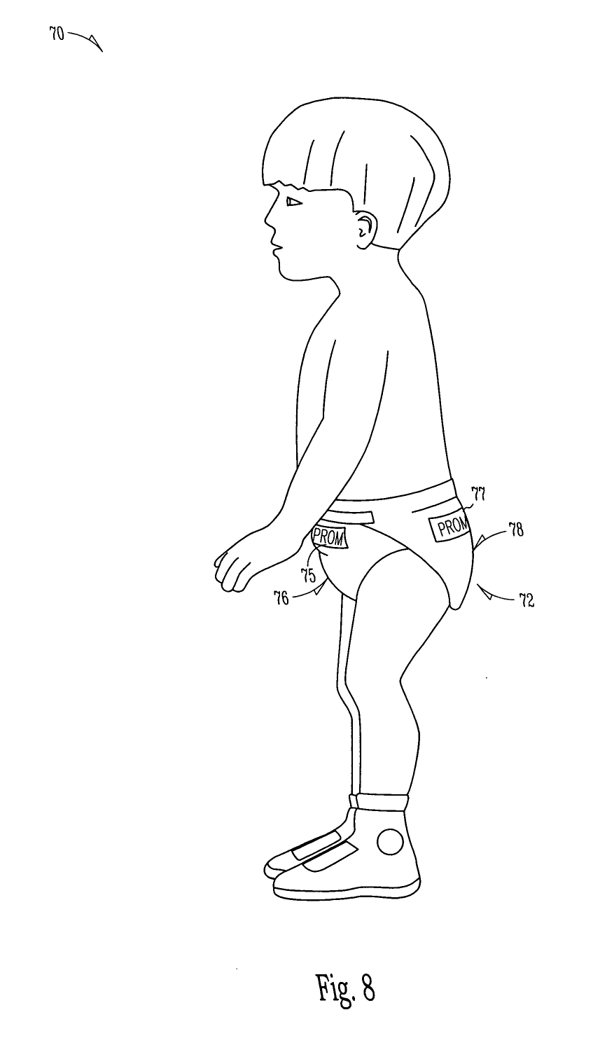

In some forms, each of the diapers 72 includes one or more promotions. As an example, FIG. 8 shows that each of the diapers 72 may includes a first promotion 75 on a front 76 of the diapers 72 and a second promotion 77 on a back 78 of the diapers 72.

It should be noted that the promotions 74 may relate to purchasing diapers and/or products other than diapers. As an example, the first promotion 75 may be related to purchasing a product (e.g., hamburgers) other than diapers and the second promotion 77 may be related to purchasing diapers.

Some example promotions include “Buy 1, get 1 free”, “25 cents off next purchase”, “Free fries with the purchase of a soda”, “You have won a free package of diapers”. The types of products that are included in the promotions will depend on the application where the system is used. In addition, the number and location of the promotions on the diapers may vary from one system to another.

As used herein, “diaper” refers to diapers that may be used with boys and girls as well as children and adults. In addition, diaper may refer to products associated with feminine hygiene.

The operations discussed above with respect to the described methods may be performed in a different order from those described herein. While the invention has been described in detail with respect to the specific aspects thereof, it will be appreciated that those skilled in the art, upon attaining an understanding of the foregoing, may readily conceive of alterations to, variations of, and equivalents to these aspects which fall within the spirit and scope of the present invention, which should be assessed accordingly to that of the appended claims.

1. A method of advertising, the method comprising:
selling space on diapers to a sponsor; and
placing an ad for a product other than diapers onto the diapers.

2. The method of claim 1 further comprising manufacturing the diapers.

3. The method of claim 1 further comprising selling the diapers to customers.

4. The method of claim 1 wherein the ad is a first ad, the product is a first product and the sponsor is a first sponsor such the method further comprises:
selling space on diapers to a second sponsor; and
placing a second ad for a second product other than diapers onto the diapers.

5. The method of claim 4 wherein placing the first ad onto the diapers includes placing the first ad on a front of the diapers, and placing the second ad onto the diapers includes placing the second ad on a back of the diapers.

6. The method of claim 1 wherein placing the ad onto the diapers includes printing the ad onto the diapers.

7. The method of claim 1 wherein placing the ad onto the diapers includes affixing a detachable ad onto the diapers.

8. A system for generating advertising revenue comprising:
diapers; and
ads for products other diapers placed onto the diapers.

9. The system of claim 8 wherein each of the diapers includes one ad.

10. The system of claim 8 wherein each of the diapers includes a first ad on a front of the diapers and a second ad on a back of the diapers.

11. The system of claim 10 wherein the first ad is for a first product other than diapers and the second ad is for a second product other than diapers.

12. The system of claim 8 wherein the ads are printed onto the diapers.

13. The system of claim 8 wherein the ads are detachable from the diapers.

14. A method of promoting product purchases, the method comprising:
placing a promotion relating to purchasing the product onto diapers; and
selling the diapers to customers.

15. The method of claim 14 further comprising manufacturing the diapers.

16. The method of claim 14 wherein placing a promotion onto the diapers includes placing a promotion relating to purchasing diapers onto the diapers.

17. The method of claim 14 wherein placing a promotion onto the diapers includes placing a promotion relating to purchasing a product other than diapers onto the diapers.

18. The method of claim 14 wherein placing a promotion onto the diapers includes placing a coupon for purchasing the product onto the diapers.

19. The method of claim 18 wherein placing a coupon for purchasing the product onto the diapers includes affixing a detachable coupon onto the diapers.

20. The method of claim 14 wherein placing a promotion onto the diapers includes selling space on the diapers to a sponsor to place the promotion onto the diapers.

21. The method of claim 14 wherein placing a promotion onto diapers includes placing a portion of a contest onto the diapers.

22. A system for promoting product purchases, the system comprising:
diapers; and
promotions related to purchasing the products, the promotions being placed onto the diapers.

23. The system of claim 22 wherein each of the diapers includes at least one promotion.

24. The system of claim 22 wherein each of the diapers includes a first promotion on a front of the diapers and a second promotion on a back of the diapers.

25. The system of claim 22 wherein the promotions relate to purchasing diapers.

26. The system of claim 22 wherein the promotions relate to purchasing products other than diapers.

27. The system of claim 22 wherein each of the diapers includes a first promotion that is related to purchasing a product other than diapers and a second promotion that is related to purchasing diapers.

28. The system of claim 22 wherein the promotions are printed onto the diapers.

29. The system of claim 22 wherein the promotions are detachable from the diapers.

30. The system of claim 22 wherein the promotions are detachable coupons related to purchasing the products.
